(19) United States
(12) Patent Application Publication
(10) Pub. No.: US 2012/0253804 A1
(43) Pub. Date: Oct. 4, 2012

(54) VOICE PROCESSOR AND VOICE PROCESSING METHOD

(75) Inventors: Chikashi SUGIURA, Hamura-shi (JP); Hiroshi Fujimura, Yokohama-shi (JP); Akinori Kawamura, Kunitachi-shi (JP); Takashi Sudo, Fuchu-shi (JP)

(73) Assignee: Kabushiki Kaisha Toshiba, Tokyo (JP)

(21) Appl. No.: 13/328,251

(22) Filed: Dec. 16, 2011

(30) Foreign Application Priority Data
Mar. 31, 2011 (JP) 2011-080365

(51) Int. Cl. G10L 15/26

(52) U.S. Cl. 704/235; 704/E15.043

(57) ABSTRACT

According to one embodiment, a voice processor includes: a storage module; a converter; a character string converter; a similarity calculator; and an output module. The storage module stores therein first character string information and a first phoneme symbol corresponding thereto in association with each other. The converter converts an input voice into a second phoneme symbol. The character string converter converts the second phoneme symbol into second character string information in which content of the voice is described in a natural language. The similarity calculator calculates similarity between the input voice and a portion of the first character string information stored in the storage module using at least one of the second phoneme symbol converted by the converter and the second character string information converted by the character string converter. The output module outputs the first character string information based on the similarity calculated by the similarity calculator.

### CROSS-REFERENCE TO RELATED APPLICATIONS

This application is based upon and claims the benefit of priority from Japanese Patent Application No. 2011-080365, filed on Mar. 31, 2011, the entire contents of which are incorporated herein by reference.

### FIELD

Embodiments described herein relate generally to a voice processor and a voice processing method.

### BACKGROUND

In recent years, more and more information processors such as smartphones and tablet terminals have been sold. Such information processors have no input device such as a key board and a mouse, and are instead operated based on the touch control via a touch panel. For such information processors, a word prediction technology has been developed for displaying, when a character string is being input by touch control, predicted word candidates including the character string.

On the other hand, as a method for inputting the character string, there has been proposed a technology for performing voice recognition of an input voice using a microphone or the like provided to an information processor, to generate the character string. Thus, the word prediction technology for displaying the predicted word candidates may be applied to the method for inputting a character string by using the voice recognition.

If the word prediction technology is employed, a portion from the beginning of the character string stored in advance needs to be identical to the character string converted from the input voice. However, false recognition or the like is likely to occur when the voice is converted into the character string by voice recognition. As a result, it is difficult to apply the predictive conversion technology to the voice recognition.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic external view of an information processor according to an embodiment;

FIG. 2 is an exemplary block diagram of a hardware configuration of the information processor in the embodiment;

FIG. 3 is an exemplary block diagram of a software configuration realized in the information processor in the embodiment;

FIG. 4 is an exemplary view of a first example of a screen displayed by the information processor in the embodiment;

FIG. 5 is an exemplary view of a second example of the screen displayed by the information processor in the embodiment;

FIG. 6 is an exemplary view of a third example of the screen displayed by the information processor in the embodiment;

FIG. 7 is an exemplary view of a fourth example of the screen displayed by the information processor in the embodiment; and

FIG. 8 is an exemplary flowchart of a process until character string data to be translated is selected in the information processor in the embodiment.

### DETAILED DESCRIPTION

In general, according to one embodiment, a voice processor comprises: a storage module; a converter; a character string converter; a similarity calculator; and an output module. The storage module is configured to store therein first character string information and a first phoneme symbol corresponding to the first character string information in association with each other. The converter is configured to convert an input voice into a second phoneme symbol. The character string converter is configured to convert the second phoneme symbol into second character string information in which content of the voice is described in a natural language. The similarity calculator is configured to calculate similarity between the input voice and a portion of the first character string information stored in the storage module using at least one of the second phoneme symbol converted by the converter and the second character string information converted by the character string converter. The output module is configured to output the first character string information based on the similarity calculated by the similarity calculator.

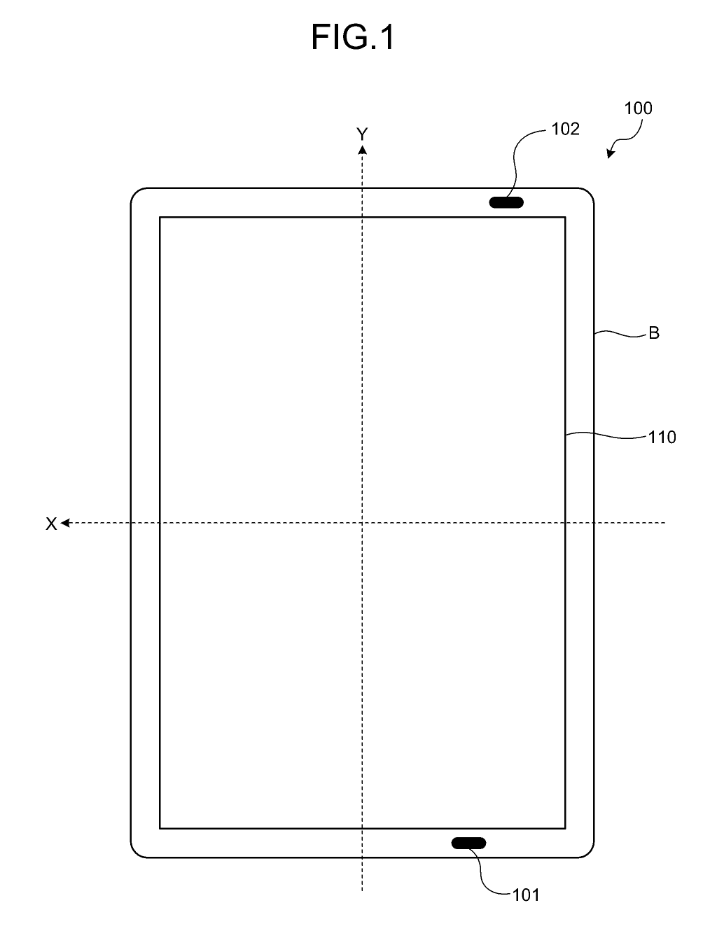

FIG. 1 is a schematic external view of an information processor according to a present embodiment. An information processor 100 is a voice processor comprising a display screen. The information processor 100 is realized as, for example, a slate terminal (tablet terminal) or a document input device based on voice recognition. It is to be noted that arrow directions of the X-axis and the Y-axis are positive directions (hereinafter, the same will apply).

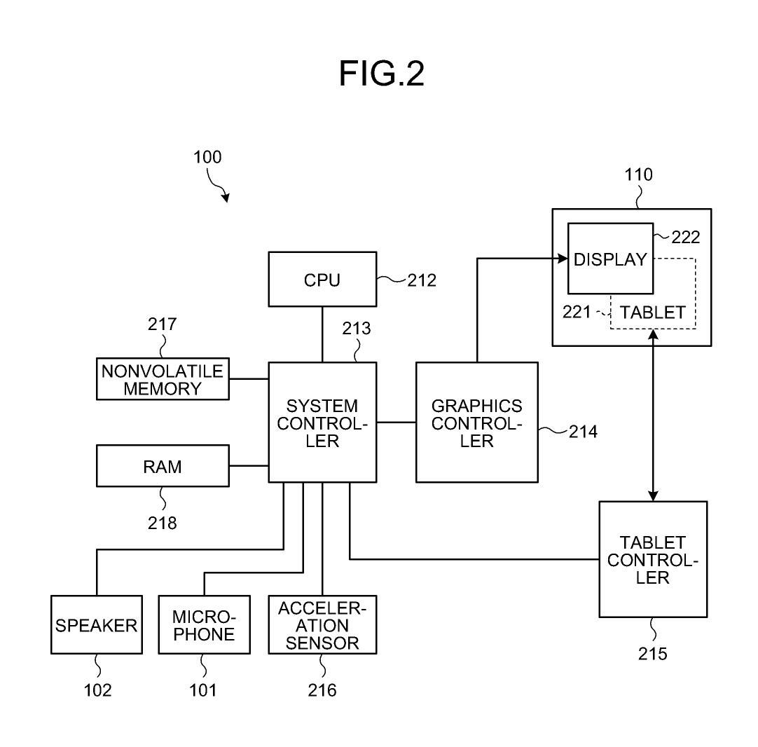

The information processor 100 comprises a thin box-shaped casing B, and a display module 110 is arranged on the upper surface of the casing B. The display module 110 comprises a tablet (refer to a tablet 221 in FIG. 2) for detecting a position touched by a user on the display screen. The information processor 100 further comprises a microphone 101 for receiving a voice output by the user, and a speaker 102 for outputting a voice to the user. The information processor 100 is not limited to the example illustrated in FIG. 1, and may have a form in which various types of button switches are arranged on the upper surface of the casing B.

FIG. 2 is a block diagram illustrating a hardware configuration of the information processor 100 according to the embodiment. As illustrated in FIG. 2, the information processor 100, in addition to the display module 110, the microphone 101, and the speaker 102 described above, comprises a central processing unit (CPU) 212, a system controller 213, a graphics controller 214, a tablet controller 215, an acceleration sensor 216, a nonvolatile memory 217, and a random access memory (RAM) 218.

The display module 110 comprises: the tablet 221; and a display 222 such as a liquid crystal display (LCD) or an organic electroluminescence (EL). The tablet 221, for example, comprises a transparent coordinate detecting device arranged on the display screen of the display 222. As described above, the tablet 221 can detect a position (touch position) touched by a finger of the user on the display screen. Such an operation of the tablet 221 allows the display screen of the display 222 to function as a so-called touch screen.

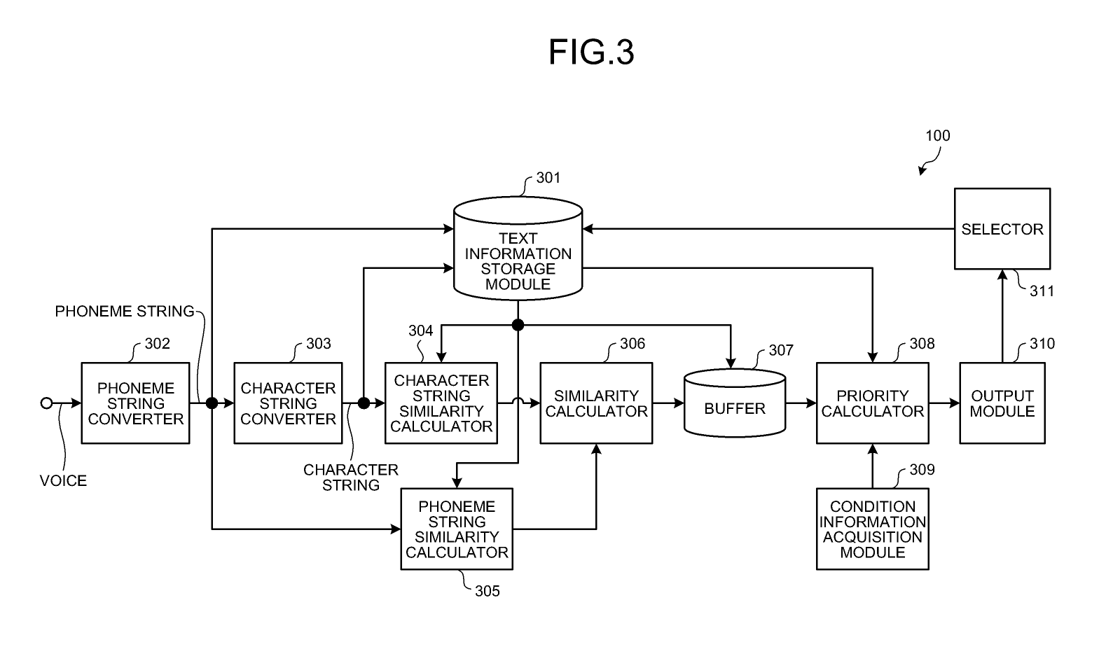

The CPU 212 is a processor that controls operations of the information processor 100, and controls each component of the information processor 100 via the system controller 213. The CPU 212 executes an operating system and various types of application programs loaded on the RAM 218 from the nonvolatile memory 217, thereby realizing each module (see FIG. 3), which will be described later. The RAM 218 functions as a main memory of the information processor 100.

The system controller 213 comprises a memory controller therein that performs access control on the nonvolatile memory 217 and the RAM 218. Furthermore, the system controller 213 performs communicate with the graphics controller 214.

The graphics controller 214 is a display controller that controls the display 222 used as a display monitor of the information processor 100. The tablet controller 215 controls the tablet 221, and acquires coordinate data indicating a position touched by the user on the display screen of the display 222 from the tablet 221.

The acceleration sensor 216 is an acceleration sensor or the like that performs the detection in the axial direction (X and Y directions) illustrated in FIG. 1 or the detection in the rotational direction of each of the axes in addition to the detection in the axial direction. The acceleration sensor 216 detects the direction and the magnitude of the acceleration from outside with respect to the information processor 100, and outputs the direction and the magnitude to the CPU 212. Specifically, the acceleration sensor 216 outputs an acceleration detection signal including the axis with respect to which the acceleration is detected, the direction (in case of rotation, the angle of rotation), and the magnitude, to the CPU 212. A gyro sensor for detecting the angular velocity (angle of rotation) may be integrated in the acceleration sensor 216.

A software configuration realized by executing a voice processing program in the CPU 212 of the information processor 100 will now be described. FIG. 3 is a diagram of the software configuration realized in the information processor 100 according to the embodiment. As illustrated in FIG. 3, the information processor 100 comprises a text information storage module 301, a phoneme string converter 302, a character string converter 303, a character string similarity calculator 304, a phoneme string similarity calculator 305, a similarity calculator 306, a buffer 307, a priority calculator 308, a condition information acquisition module 309, an output module 310, and a selector 311.

The text information storage module 301 is provided in the nonvolatile memory 217 in FIG. 2, and stores therein a plurality of pieces of character string data and symbol strings of phonemic symbols corresponding to the pieces of character string data, respectively, in association to each other. For example, the text information storage module 301 stores therein a piece of character string data of “konnichiwa” and a piece of phoneme string data of “KonNichiwa” (an image of phoneme) in association to each other.

Furthermore, the text information storage module 301 may store therein each text in a manner corresponding to a hit rate or a value equivalent thereto. In the information processor 100 according to the present embodiment, the case in which character string data stored in the text information storage module 301 is identical to a voice recognition result, or the case in which character string data is selected by the selector 311, which will be described later, is referred to as a hit, and the rate of the hit is referred to as the hit rate. In the present embodiment, the character string data is stored in the text information storage module 301 by sentence. As a result, the character string data is presented by sentence as a selection candidate, thereby allowing the user to select and to specify the sentence to be an object of processing in a simple manner without speaking up the whole sentence. If the character string data is displayed by bunsetsu segmentation (linguistic/articulation unit of Japanese), the user needs to perform a selection operation frequently. However, since the character string data is presented by sentence, it becomes possible to reduce a burden in the selection.

As described above, the text information storage module 301 according to the present embodiment retains therein a symbol string of phonemes for each piece of the character string data. This allows the information processor 100 to determine the similarity at a symbol level. Therefore, if bunsetsu segmentation is segmented incorrectly because of a speech error by the user or false recognition, or even if input character string data converted and generated from the voice contains a false description, it is possible to raise the probability of the selection candidate intended by the user being displayed.

In the information processor 100 according to the present embodiment, if the character string data stored in the text information storage module 301 is hit, the phoneme string data and the character string data converted from the voice input from the microphone 101 may be stored in a manner corresponding to the character string data thus hit (stored in the text information storage module 301) as a hit object. Using the phoneme string and the character string thus stored for comparison thereafter makes it possible to improve the accuracy of the voice recognition.

Furthermore, in the information processor 100 according to the present embodiment, if the character string data stored in the text information storage module 301 is hit, condition information, such as external environmental information including a date, time of the day, weather, and a current location, an intended use of the voice recognition, and a profile of the user acquired by the condition information acquisition module 309, which will be described later, may be stored in a manner corresponding to the character string data.

Instead of calculating the hit rate of the number hits with respect to the total number of hits, the information processor 100 may use the condition information described above to calculate a conditional rate, and use the conditional rate as the hit rate.

The phoneme string converter 302 converts a voice signal input from the microphone 101 into a phoneme symbol (hereinafter, referred to as a phoneme) having an acoustic feature value of the voice. The phoneme string converter 302 according to the present embodiment calculates the acoustic feature value such as Mel-Frequency Cepstral Coefficients (MFCC) from the voice signal thus input. The phoneme string converter 302 then uses a statistical method such as Hidden Markov Model (HMM) to convert the voice signal into a phoneme symbol. However, the phoneme string converter 302 may use other methods.

The character string converter 303 converts the phoneme converted by the phoneme string converter 302 into input character string data in which a content output by the voice is described in a natural language.

The character string similarity calculator 304 calculates character string similarity indicating the similarity between the input character string data converted by the character string converter 303 and partial character string data that is a portion of the character string data stored in the text information storage module 301. As for the portion of the character string data, the character string similarity calculator 304 according to the present embodiment uses the partial character string data that is a portion from the beginning character of the character string data as an object of calculation of the character string similarity.

The phoneme string similarity calculator 305 calculates phoneme similarity indicating the similarity of phonemes between the symbol string of the phonemes converted by the phoneme string converter 302 and a partial phoneme symbol string that is a portion of the symbol string of the phonemes corresponding to the character string data stored in the text information storage module 301. As for the partial phoneme symbol string, the phoneme string similarity calculator 305 according to the present embodiment uses partial phoneme symbol string data that is a portion from the beginning character of the symbol string of the phonemes stored in the text information storage module 301 as an object of calculation of the phoneme similarity.

The similarity calculator 306 calculates the similarity between the input voice and each piece of the character string data stored in the text information storage module 301. The similarity calculator 306 according to the present embodiment calculates the similarity based on the weighted sum of the character string similarity and the phoneme similarity. In the similarity calculator 306 according to the present embodiment, if any one of weights of the character string similarity and the phoneme similarity used for calculating the weighted sum is “0”, the similarity is calculated by using the other alone. The similarity calculator 306 may use any one of the character string similarity and the phoneme similarity alone in this manner.

The buffer 307 is provided in the RAM 218, and retains therein the similarity calculated by the similarity calculator 306 temporarily in a manner corresponding to a storage ID indicating a storage location of the character string data serving as the object of calculation of the similarity in the text information storage module 301.

The condition information acquisition module 309 acquires at least one of the conditions, such as the external environmental information including the current date, the time of the day, the weather, and the current location, the intended use of the voice recognition, and the profile of the user.

The priority calculator 308 calculates the priority for each piece of the character string data based on the similarity retained in the buffer 307, that is, based on at least one of the phoneme similarity and the character string similarity. The priority calculator 308 according to the present embodiment calculates the priority not only by using the similarity but also by using the hit rate corresponding to the character string data in combination. The priority calculator 308, for example, uses a calculation method in which the character string data is given high priority if the similarity thereof is equal to or more than a predetermined threshold value, and the number of hits thereof is large.

Furthermore, the priority calculator 308 refers to at least one of the conditions, such as the date, the time of the day, the weather, the current location, the intended use of the voice recognition, and the profile of the user acquired by the condition information acquisition module 309, and calculates the priority such that the character string data containing the character string corresponding to the conditions is given high priority.

The priority calculator 308 then extracts the character string data containing a portion similar to the input voice as a selection candidate based on the priority thus calculated. The priority calculator 308 according to the present embodiment, if the priority thus calculated is equal to or higher than a predetermined threshold value, extracts the character string data identified by the storage ID corresponding to the similarity used for calculating the priority in the buffer 307 as a selection candidate. The condition for extracting the character string data as the selection candidate based on the priority is not limited to the case in which the priority is equal to or higher than the predetermined threshold value. For example, the priority calculator 308 may extract upper n-pieces of the character string data in order of priority. Furthermore, by combining the predetermined threshold value and the upper n, the priority calculator 308 may extract the upper-n pieces of the character string data even if the priorities thereof are equal to or lower than the predetermined threshold value.

In the present embodiment, the priority is calculated by combining the hit rate and at least one of the various conditions with the similarity. However, the priority is not necessarily to be calculated by such a calculation method. For example, the similarities stored in the buffer 307 may be calculated as the priorities in descending order. In another example, if the similarity stored in the buffer 307 is equal to or larger than the predetermined threshold value, the character string data corresponding to the similarity may be referred to from the text information storage module 301 to determine the hit rate corresponding to the character string data as the priority. The hit rate may be the conditional rate.

The output module 310 outputs the character string data stored in the text information storage module 301 in order of the priority as selection candidates to the display module 110. Furthermore, the output module 310 may output the character string data not to the display module 110, but to an external device via a communication module, such as a wired communication module (not illustrated) and a wireless communication module (not illustrated).

If the similarities of the whole character string data do not exceed the predetermined threshold value, the output module 310 outputs the input character string data converted by the character string converter 303 as a selection candidate to the display module 110.

When outputting the character string data as the selection candidates, the output module 310 may cause the character string data to be displayed in an eye-catching display color, in an eye-catching character size, in an eye-catching font, at a conspicuous position, with an eye-catching movement, and in other formats in accordance with the priorities.

The selector 311 selects the character string data output by the output module 310. The selector 311 according to the present embodiment selects the character string data instructed by the user via the tablet 221 as an object of use. The method for selecting the character string data is not limited to the instruction issued via the tablet 221. The selection may be received, for example, by depression of a hard key or the like, or a software key or the like.

If a predetermined time has passed without any instruction from the user in a state where the display module 110 displays the character string data, the selector 311 may select the character string data with the highest priority automatically.

If the predetermined time has passed without any instruction from the user in the state where the display module 110 displays the character string data, the information processor 100 may determine that no character string data of the speech intention is present, and may go to a process for repeating the voice input. Furthermore, if the predetermined time has passed without any instruction from the user in the state where the display module 110 displays the character string data, the information processor 100 may provide a display for asking a permission from the user before performing the processing automatically.

The information processor 100 having the configuration described above may be used for simultaneous translation in selling at a shop to a foreigner or other use. In other words, the text information storage module 301 of the information processor 100 may store therein character string data in Japanese and character string data in foreign languages corresponding to the character string data in Japanese in association with each other. If the intended use is restricted in this manner, the voice to be output is narrowed down to some extent, thereby making it possible to improve the recognition rate and to increase the processing speed.

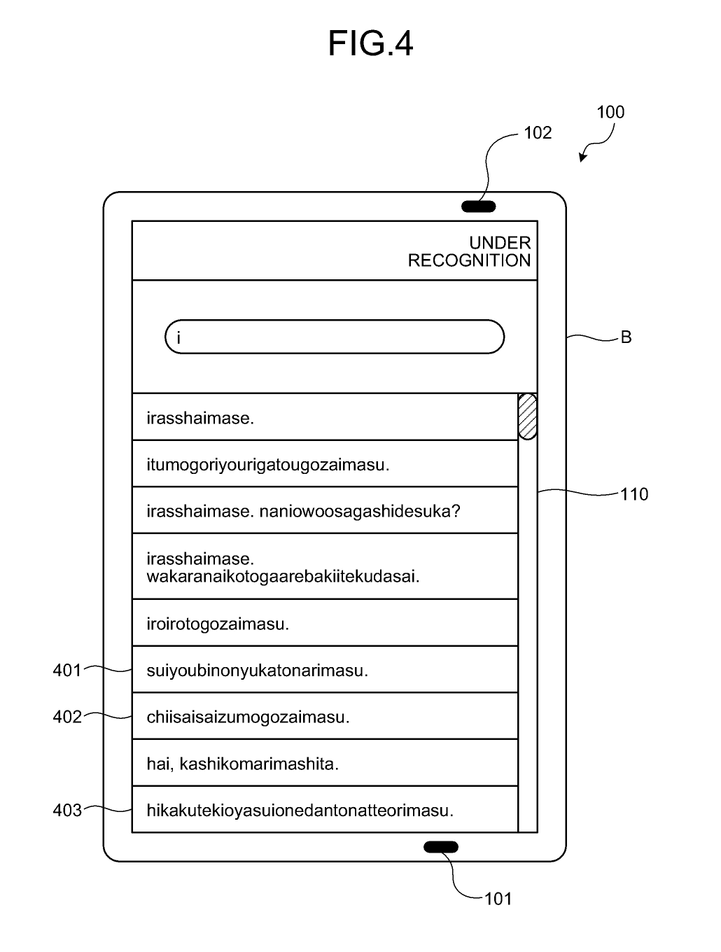

An example of a screen of the information processor 100 will now be described. FIG. 4 is a view illustrating the screen displayed by the information processor 100 according to the embodiment when a voice “i” is input. As illustrated in FIG. 4, when the user outputs the voice “i”, the information processor 100 displays character string data whose phoneme or character string is similar to that of the voice “i” on the display module 110 as a candidate list.

As illustrated in FIG. 4, the display module 110 displays “irasshaimase.”, “itumogoriyouarigatougozaimasu.”, “irasshaimase. naniwoosagashidesuka?”, “irasshaimase. wakaranaikotogaarebakiitekudasai.”, “iroirotogozaimasu ”, “suiyoubinonyukatonarimasu.”, “chiisaisaizumogozaimasu.”, “hai, kashikomarimashita.”, and “hikakutekioyasuionedanntonatteorimasu.” as the candidate list. Here, the candidates displayed by the display module 110 are described in a Japanese romanization system for transcribing the Japanese language into the Latin alphabet. This system used in this embodiment is further standardized under ISO 3602.

At this stage, because it is easier to continue the speech than to select the candidate list, the user continues the speech. Because a beginning of a word creates ambiguity in the search, while the speech is started with “i”, a candidate started with a character other than “i” (however, a candidate containing a vowel “i” as a phoneme adjacent to the beginning of the word) is also displayed. Examples of the candidate whose beginning of the sentence is a character other than “i” include a character string whose beginning of the sentence is a character in the “i” column (ki, shi, chi, ni, hi, mi, ri, . . . ). In addition, the second character maybe “i”. As a result, the display module 110 displays “suiyoubinonyukatonarimasu” 401, “chiisaisaizumogozaimasu” 402, and “hikakutekioyasuionedanntonatteorimasu” 403. The example illustrated in FIG. 4 is an example in which the order of frequency of being spoken previously is used as the priority. The order of frequency is stored in a manner corresponding to the character string data in the text information storage module 301.

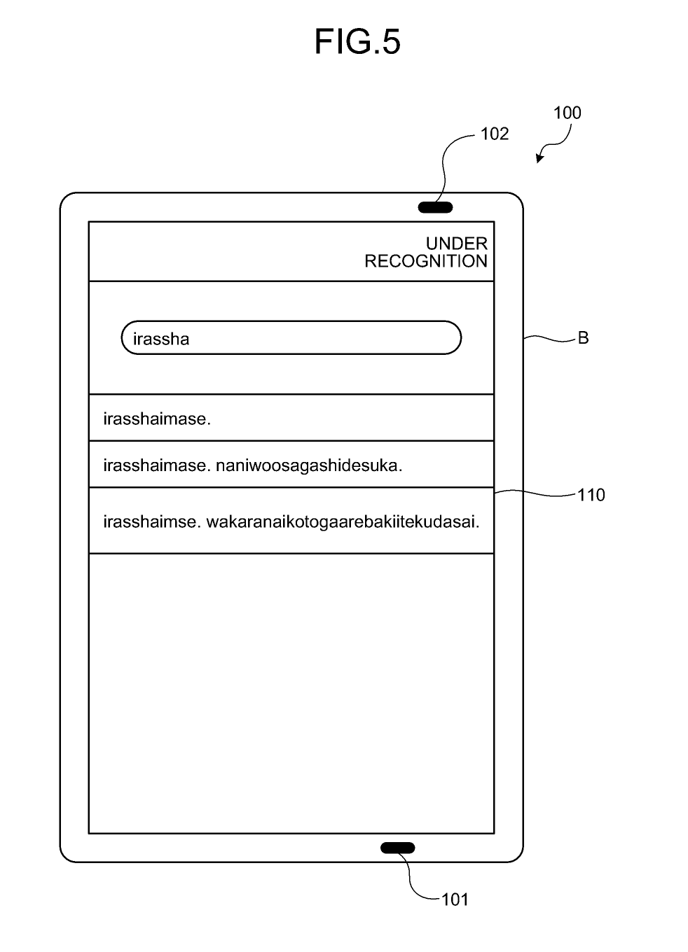

An assumption is made that the user then continues the speech. FIG. 5 is a view illustrating the screen displayed by the information processor 100 according to the embodiment when a voice “irassha” is input. As illustrated in FIG. 5, when the user outputs the voice “irassha”, the information processor 100 displays character string data whose phoneme or character string is similar to that of the voice “irassha” on the display module 110 as a candidate list.

As illustrated in FIG. 5, at this stage, the candidate list displayed by the display module 110 is narrowed down to the character string data containing “irassha”. If the candidate is narrowed down to such an extent, the user may stop the speech to point out the character string data illustrated in FIG. 5, or may continue the speech. If the user points out the character string data, the selector 311 selects the character string data pointed out by the user as the character string data to be an object of translation.

If the user further continues the speech, that is, if the user says “irasshaimase. na . . . ”, for example, the display module 110 displays the character string data of “irasshaimase. naniwoosagashidesuka?” alone, as the candidate list. At this stage, the user may select the character string data, or may complete the speech to the end.

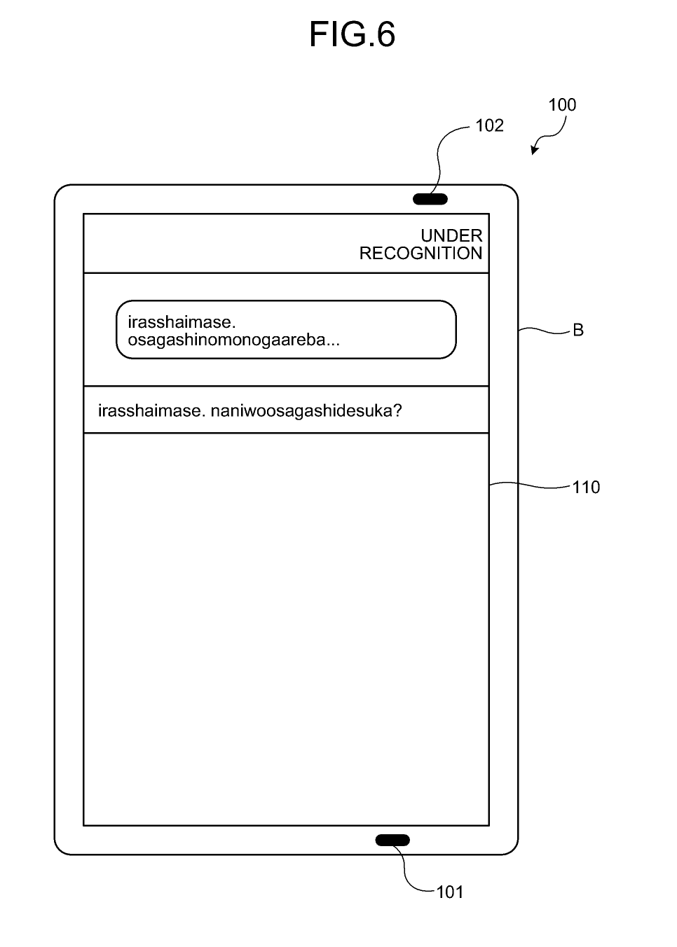

In the information processor 100 according to the present embodiment, the character string data stored in the text information storage module 301 is not necessarily identical to the voice output by the user. As far as being similar thereto, the character string data is displayed as the candidate list. FIG. 6 is a view illustrating the screen displayed by the information processor 100 according to the embodiment when a voice “irasshaimase. osagashinomonogaareba . . . ” is input. As illustrated in FIG. 6, when the user outputs the voice “irasshaimase. osagashinomonogaareba . . . ”, the information processor 100 displays “irasshaimase. naniwoosagashidesuka?” that is character string data whose phoneme or character string is similar to that of the voice “irassha”, and that is stored in the text information storage module 301 on the display module 110 as a candidate list.

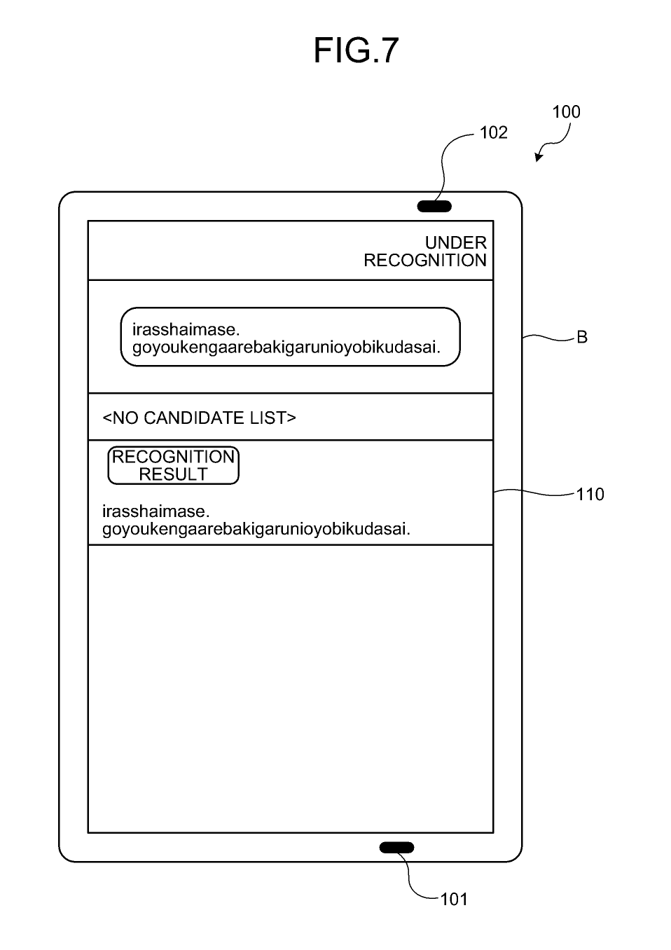

Furthermore, in the information processor 100 according to the present embodiment, the character string data stored in the text information storage module 301 is not necessarily identical to the voice output by the user. If no character string data similar thereto is present, the information processor 100 displays character string data converted from the symbol string of the phonemes based on the input voice. FIG. 7 is a view illustrating the screen displayed by the information processor 100 according to the embodiment when no candidate is present in the character string data stored in the text information storage module 301. As illustrated in FIG. 7, when the user outputs a voice “irasshaimase. goyoukenngaarebakigarunioyobikudasai.”, because no candidate is present in the character strings stored in the text information storage module 301, the information processor 100 displays character string data “irasshaimase. goyoukenngaarebakigarunioyobikudasai” converted from the symbol string of the phonemes of the input voice on the display module 110 as a candidate list. In the information processor 100, if the user selects the character string, character string data in foreign languages is generated by using machine translation or the like.

If the user selects the character string data “irasshaimase. goyoukenngaarebakigarunioyobikudasai”, the selector 311 stores the character string data in a manner corresponding to the symbol string of the phonemes prior to being converted into the character string data in the text information storage module 301. As a result, when the user says “irasshaimase. goyoukenngaarebakigarunioyobikudasai” thereafter, the information processor 100 can display “irasshaimase. goyoukenngaarebakigarunioyobikudasai” as a selection candidate on the display module 110 before the user completes the speech to the end.

The information processor 100 according to the present embodiment then performs speech synthesis on character string data in foreign languages corresponding to the character string data in Japanese thus selected, or character string data in foreign languages generated by machine translation or the like based on the character string data in Japanese thus selected, and outputs the data from the speaker 102.

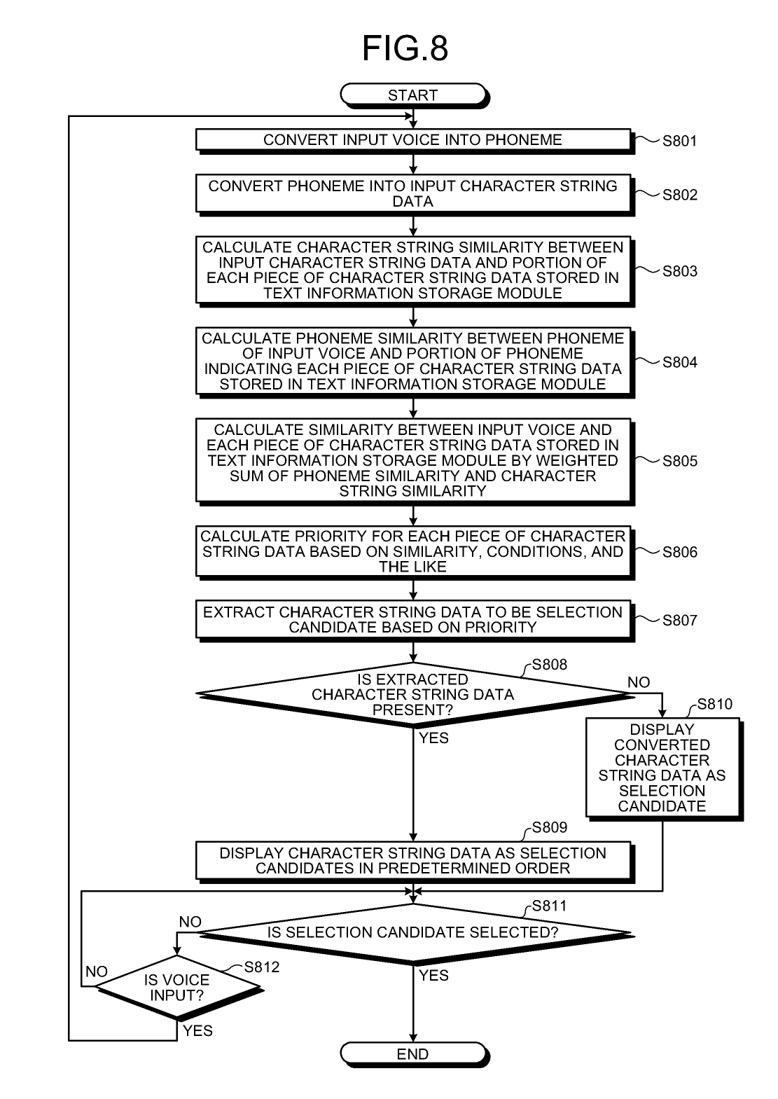

The processing performed until the character string data to be an object of translation is selected in the information processor 100 according to the present embodiment will now be described. FIG. 8 is a flowchart of the process described above in the information processor 100 according to the present embodiment.

The phoneme string converter 302 of the information processor 100 converts a voice signal thus input into a phoneme (S801).

Subsequently, the character string converter 303 converts the symbol string of the phonemes thus converted into input character string data described in a natural language (S802).

The character string similarity calculator 304 then calculates the character string similarity between the input character string data and the partial character string data that is a portion of the character string data stored in the text information storage module 301 (S803). When the input character string data is for example one character, the partial character string data that is a portion of the character string data corresponds to one or two beginning characters of the character string data stored in the text information storage module 301. The character string data containing the partial character string data similar to the input character string data is determined to be the selection candidate. As the number of the character strings of the input character string data increases, the number of pieces of the partial character string data to be compared therewith increases.

Subsequently, the phoneme string similarity calculator 305 calculates the phoneme similarity indicating the similarity of the phonemes between the symbol string of the phonemes converted by the phoneme string converter 302 and the partial phoneme symbol string that is a portion of the symbol string of the phonemes corresponding to the character string data stored in the text information storage module 301 (S804). The partial phoneme symbol string data is a portion corresponding to the symbol string of the phonemes of the input voice among the phoneme symbol strings stored in the text information storage module 301.

The similarity calculator 306 then calculates the similarity between the input voice and each piece of the character string data stored in the text information storage module 301 based on the weighted sum of the character string similarity and the phoneme similarity (S805). The similarity thus calculated is stored in the buffer 307 temporarily in a manner corresponding to the storage ID. By contrast, the condition information acquisition module 309 acquires the conditions such as the date of the present day.

The priority calculator 308 then calculates the priority for each piece of the character string data based on the similarity retained in the buffer 307, the conditions thus acquired, and the like (S806).

Subsequently, the priority calculator 308 extracts the character string data containing a portion similar to the input voice as a selection candidate based on the priority thus calculated (S807).

The output module 310 then determines whether the character string data thus extracted is present (S808). If the character string data thus extracted is present (Yes at S808), the output module 310 displays the character string data on the display module 110 as the selection candidates in a predetermined order (S809). Examples of the predetermined order include the order of priority, and the order of frequency of being spoken previously. The order can be set optionally by the user. By contrast, if the character string data thus extracted is not present (No at S808), the output module 310 displays the input character string data converted by the character string converter 303 on the display module 110 as a selection candidate (S810). As described above, if the character string data to be a candidate list is present in the text information storage module 301, the character string data is displayed. By contrast, if no character string data to be the candidate list is present in the text information storage module 301, the input character string data converted from the voice of the user is displayed.

Subsequently, the selector 311 determines whether the character string data or the input character string data serving as the selection candidate is selected by the user (S811). If the selector 311 determines that the character string data or the input character string data is not selected (No at S811), the information processor 100 determines whether a voice is input from the microphone 101 (S812). If the information processor 100 determines that a voice is input (Yes at S812), the information processor 100 performs the processing from S801 again. If the information processor 100 determines that no voice is input (No at S812), the selector 311 redetermines whether the selection candidate is selected (S811). If the selection candidate is selected (Yes at S811), it is considered that the character string data to be an object of translation is determined, and the processing is completed.

In the conventional voice recognition, the user needs to speak up the words corresponding to the whole character string data to be an object of the processing by a voice. However, the information processor 100 according to the present embodiment displays the character string data containing a portion similar to the voice thus output as the selection candidate. As a result, the user needs not to speak up the entire words corresponding to the whole data, whereby it is possible to reduce a burden of the user. Furthermore, the user needs not to speak up the entire words corresponding to the whole data, whereby it is possible to prevent false recognition from occurring in a noisy environment.

Furthermore, the information processor 100 according to the present embodiment displays not each bunsetsu segmentation as the selection candidate, but a whole sentence as the selection candidate. As a result, the user needs not to select the selection candidate by bunsetsu segmentation sequentially, whereby it is possible to reduce a burden in the operation.

Furthermore, the information processor 100, when determining the similarity using the character string data converted by the phoneme string converter 302, eases the conditions for a search for the beginning of a word. This is because the beginning of a word is likely to be falsely recognized. Performing the processing can prevent the character string data desired by the user from being excluded from the selection candidate.

The information processor 100 according to the embodiment, when displaying the candidate list, compares the voice and the character string data stored in advance during the voice recognition, and displays the character string data with high similarity or high frequency of use preferentially. This makes it possible to improve the operability.

The information processor 100 according to the embodiment determines the similarity of the phonemes and the character strings described above. As a result, it is possible to extract the character string data whose speech intention is similar to that of the voice as a selection candidate even if the document data thus generated is different from the character string data. Furthermore, some speech errors and false recognition can be absorbed.

In the conventional technology, when the voice recognition is performed, an utterer needs to wait until a result of the voice recognition is output after outputting the voice. By contrast, if the utterer wants to input specific fixed character string data a plurality of times, the utterer needs to repeat the same speech a plurality of times, thereby causing a burden.

By contrast, the information processor 100 according to the embodiment, while converting a voice being input into a phoneme string and a character string, sequentially calculates the similarity of the strings with the character string data prepared in advance, or the character string data being spoken previously, and displays the character string data on the display module 110 in order of the priority. Enabling the utterer to select the character string data in real time in this manner can reduce the burden caused when the utterer inputs a character string fixed to some extent a plurality of times. Furthermore, even if false recognition occurs because of an influence of environmental noise, or a speech habit of the utterer (e.g., tutting before the speech), the character string data to be a candidate is displayed in order of the priority based on the similarity, and thus the user can select intended character string data from the candidate. This saves the user the trouble of correction of the speech, text editing, and the like. In particular, if the user inputs a voice that is fixed to some extent and repeated a plurality of times, the user can accomplish a purpose of the voice input only by a selection operation without completing the speech to the end.

The voice processing program executed in the information processor 100 according to the present embodiment may be provided in a manner recorded in a computer-readable recording medium, such as a compact disk read-only memory (CD-ROM), a flexible disk (FD), a compact disk recordable (CD-R), and a digital versatile disk (DVD), as a file in an installable or executable format.

The voice processing program executed in the information processor 100 according to the present embodiment may be provided in a manner stored in a computer connected to a network such as the Internet to be made available for downloads via the network. Furthermore, the voice processing program executed in the information processor 100 according to the present embodiment may be provided or distributed over a network such as the Internet.

The voice processing program executed in the information processor 100 has a module configuration comprising each module described above (the phoneme string converter 302, the character string converter 303, the character string similarity calculator 304, the phoneme string similarity calculator 305, the similarity calculator 306, the priority calculator 308, the condition information acquisition module 309, the output module 310, and the selector 311). In actual hardware, the CPU (processor) reads and executes the voice processing program from the ROM described above to load each module on the main memory. Thus, the phoneme string converter 302, the character string converter 303, the character string similarity calculator 304, the phoneme string similarity calculator 305, the similarity calculator 306, the priority calculator 308, the condition information acquisition module 309, the output module 310, and the selector 311 are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice processor comprising:
storage configured to store first character string information and a first phoneme symbol corresponding to the first character string information;
an input voice converter configured to convert an input voice into a second phoneme symbol;
a character string converter configured to convert the second phoneme symbol into second character string information, in which content of the voice is described in a natural language;
a similarity calculator configured to calculate similarity between the input voice and a portion of the first character string information using the second phoneme symbol, the second character string information, or a combination thereof; and
an output configured to output the first character string information based on the similarity.

2. The voice processor of claim 1, wherein
the similarity calculator comprises:
a phoneme similarity calculator configured to calculate phoneme similarity indicating similarity between the second phoneme symbol and a partial phoneme symbol that is a portion of the first phoneme symbol;
a character string similarity calculator configured to calculate character string similarity indicating similarity between the second character string information and partial character string information that is a portion of the first character string information; or
a combination thereof, and
the output is configured to output the first character string information based on the phoneme similarity, the character string similarity, or a combination thereof.

3. The voice processor of claim 2, wherein
the phoneme similarity calculator is configured to calculate the phoneme similarity between the second phoneme symbol and a partial phoneme symbol that is a portion from a beginning of the first phoneme symbol, and
the character string similarity calculator is configured to calculate the character string similarity between the second character string information and a partial character string information that is a portion from a beginning of the first character string information.

4. The voice processor of claim 1, wherein the output is configured to output the second character string information when the first character string information does not contain a portion similar to the voice input by an extractor.

5. The voice processor of claim 1, wherein the output is configured to output the first character string information in descending order of the phoneme similarity, the character string similarity, or a combination thereof.

6. The voice processor of claim 1, further comprising:
an acquisition module configured to acquire condition information comprising current date, time of day, weather, current location, attribute information of a user, or a combination thereof, wherein
the output is configured to output the first character string information whose order is determined or that is extracted based on the condition information acquired by the acquisition module.

7. A voice processing method performed in a voice processor comprising storage configured to store first character string information and a first phoneme symbol corresponding to the first character string information, the voice processing method comprising:
converting an input voice into a second phoneme symbol;
converting the second phoneme symbol into second character string information in which content of the voice is described in a natural language;
calculating similarity between the input voice and a portion of the first character string information using the second phoneme symbol converted at the first converting, the second character string information converted at the second converting, or a combination thereof; and
outputting the first character string information based on the similarity.
